(19) United States
(12) Patent Application Publication
(10) Pub. No.: US 2020/0340414 A1
(43) Pub. Date: Oct. 29, 2020

(54) METHOD FOR THE REGENERATION OF A SOOT PARTICLE FILTER

(71) Applicant: VOLKSWAGEN AKTIENGESELLSCHAFT, Wolfsburg (DE)

(72) Inventors: Christoph NEE, Wolfsburg (DE); Christian JUNGNICKEL, Ribbesbuttel (DE)

(73) Assignee: VOLKSWAGEN AKTIENGESELLSCHAFT, Wolfsburg (DE)

(21) Appl. No.: 16/761,171

(22) PCT Filed: Oct. 5, 2018
(86) PCT No.: PCT/EP2018/077114

§ 371 Date: Jun. 3, 2020

(30) Foreign Application Priority Data
Nov. 3, 2017 (DE) 10 2017 219 594.0

(51) Int. Cl. F02D 41/02; F01N 3/023; F01L 13/00; F01L 1/047; F02D 13/06; B01D 46/00; B01D 46/42; B01D 46/44

(52) U.S. Cl. CPC F02D 41/029; F01N 3/023; F01L 13/0005; F01L 1/047; F02D 13/06; B01D 46/0057; B01D 2279/30; B01D 46/4263; B01D 46/4272; B01D 46/446; B01D 46/448; F02D 2200/0802; F02D 2200/0812; B01D 46/0042

(57) ABSTRACT

The invention relates to a method for the regeneration of a soot particulate filter that is installed on the outlet side of an internal combustion engine, comprising the following steps: detecting a loading value of the soot particulate filter; measuring an operating temperature of the soot particulate filter; switching off a cylinder of the internal combustion engine; starting a supply of fresh air to the soot particulate filter via the switched-off cylinder; adjusting a cylinder valve so as to control the supply of fresh air; regenerating the soot particulate filter. The invention further relates to a control unit, to an internal combustion engine and to a motor vehicle for carrying out a method of this kind.

The invention relates to method for the regeneration of a soot particulate filter that is installed on the outlet side of an internal combustion engine.

Soot particulate filters find widespread use in diesel engines. However, since legislation on exhaust-gas emissions is becoming increasingly stringent, higher requirements pertaining to the particles (limit values for the emitted particulate matter and for the particle number) are also becoming more relevant for gasoline engines with direct fuel injection. In this context, since the combustion process is similar to that of diesel engines, it can be assumed that there is a higher emission of particulate matter as well as a higher particle number. In order to comply with these limit values, it is also necessary for such gasoline engines to be equipped with an exhaust-gas treatment unit that, in addition to the customary three-way catalytic converter, also comprises a particulate filter.

Particulate filters or soot particulate filters capture soot particles that are formed during the combustion of fuel and that are then present in the exhaust gas stream. This reduces the particulate matter as well as the number of emitted soot particles in the exhaust gas measured at the tailpipe. Over the course of operation, the particulate filter becomes increasingly laden with soot particles. This raises the exhaust gas counterpressure, which has a negative effect on the engine performance and on the fuel consumption. For this reason, the soot particulate filter has to be regularly regenerated, that is to say, the accumulated soot has to be removed or degraded from time to time.

The filter is regenerated during separate regeneration phases by means of an oxidative burn-off of the particles to form non-toxic CO₂, in an exothermic reaction that takes place autonomously, provided that there is a sufficiently high (exhaust gas) temperature of approximately 600° C. and a sufficiently high oxygen concentration in the exhaust gas. The course of the regeneration can be controlled on the basis of the composition of the exhaust gas and the exhaust gas temperature.

The portion of oxygen present in the exhaust gas is described by a lambda value (λ), and it has a value of 1 (λ=1) in the case of stoichiometric combustion, a value greater than 1 (λ>1) for the so-called lean mode of operation in the case of an excess of oxygen, and a value smaller than 1 (λ<1) in the case of a deficit of oxygen.

An excess of oxygen is necessary for the regeneration of a soot particulate filter. When it comes to gasoline engines with classic stoichiometric combustion (λ=1), such an oxygen excess is only available during the lean mode of operation (λ>1). Combustion with an oxygen excess (80 >1) generates high NOₓ emissions since this falls outside of the conversion range of the three-way catalytic converters that are typically employed. This is why such a lean mode of operation is usually not the objective with gasoline engines.

Another approach consists of supplying the requisite oxygen via the cylinders that are running “empty” (that is to say, that are not firing) during overrun operation. Here, the wheels drive the coupled engine that is being operated without fuel injection. In this process, as the pistons are being carried along, they function as an air pump and convey fresh air and the oxygen contained therein through the engine into the soot particulate filter in order to carry out the regeneration. Such a method is shown in German patent application DE 10 2010 046 889 A1.

An overrun mode of operation can also be realized, for instance, in a hybrid drive, in which the propulsion is provided electrically and is so strong that it additionally drives the internal combustion engine that is being carried along, thus likewise conveying fresh air and the oxygen contained therein through the internal combustion engine to the soot particulate filter, where the soot that has accumulated there is then burned off. However, regeneration purely in the overrun mode of operation (without electric assistance) is only possible in those drive cycles in which overrun operation is indeed possible for a prolonged period of time (for example, a long drive downhill).

There are, however, drive cycles or operating cycles when there is not a sufficiently long period of time during which no drive torque is being required. The overrun mode of operation for regeneration purposes cannot be established, for example, via the engine control unit if there is not a simultaneous driver request to this effect.

However, due to oxygen saturation, regeneration while the internal combustion engine is turned off can also give rise to increased NOₓ emissions when the engine is subsequently started.

The objective of the present invention is to put forward a method for the regeneration of a soot particulate filter of an internal combustion engine of a motor vehicle as well as such a motor vehicle that carries out such a method in order to overcome the above-mentioned drawbacks at least partially.

This objective is achieved by means of the method according to the invention for the regeneration of an internal combustion engine arrangement according to claim 1 and by means of a motor vehicle according to claim 10.

According to a first aspect of the present invention, the method for the regeneration of a soot particulate filter that is installed on the outlet side of an internal combustion engine comprises the following:
ascertaining a load value of the soot particulate filter;
measuring an operating temperature of the soot particulate filter;
switching off a cylinder;
initiating a fresh air feed into the soot particulate filter via the switched-off cylinder;
adjusting a cylinder valve so as to regulate the fresh air feed;
regenerating the soot particulate filter.

According to a second aspect of the present invention, it comprises a control unit to operate the internal combustion engine of a motor vehicle that is configured to carry out the method according to the invention.

Additional aspects relate to an internal combustion engine having such a control unit as well as to a motor vehicle having such an internal combustion engine.

The invention is characterized in that fresh air is fed into the soot particulate filter via at least one switched-off cylinder.

The thus-increased amount of oxygen allows soot to be burned off in the soot particulate filter during driving operation (similar to the situation with a diesel vehicle) while simultaneously supplying the torque requested by the driver. In comparison to the alternative concepts that are based on setting a lean mode for the combustion, the method according to the invention does not entail limitations having to do with a reliable preparation of the mixture and the ignitability. The operation of a gasoline engine—which is, after all, designed for homogenous operation—with an excess of oxygen can cause rough running of the engine under some circumstances.

Fundamentally speaking, the method according to the invention is particularly suitable for a gasoline engine system that has a soot particulate filter (or a so-called gasoline particulate filter) that is going to be regenerated during drive operation. For this purpose, first of all, a load value of the soot particulate filter is ascertained. Then the operating temperature of the soot particulate filter is measured in order to determine whether a sufficiently high operating temperature is present that is necessary to regenerate the soot particulate filter (normally a burn-off temperature of more than 600° C. is needed).

In this context, the load can be ascertained either by measuring the pressure differential over the soot particulate filter or else by means of modeling in that the earlier operating points and the associated particle emissions over the entire past operating period are integrated so that the load of the soot particulate filter can be determined.

Subsequently, one or more cylinders of the internal combustion engine are switched off, that is to say, the fuel injection is discontinued. Here, however, fresh air continues to be conveyed from the inlet side to the outlet side of the cylinder so that the desired volume of oxygen that is necessary for the regeneration is fed into the soot particulate filter. In this process, in order to limit the thermal load on the soot particulate filter and especially so as to avoid damaging the catalytic coating, the fresh air feed and thus the oxygen supply are regulated in that at least one of the cylinder valves (inlet valve and/or outlet valve) is adjusted.

The desired regeneration of the soot particulate filter can be carried out in this manner. In this context, on the one hand, the method according to the invention can continue to meet the driver's request by means of the cylinders that continue to fire, and nevertheless, additional oxygen from the fresh air can be conveyed into the exhaust tract and thus into the soot particulate filter. On the other hand, the fresh air feed can be regulated in such a way that the thermal load during the regeneration of the soot particulate filter can be kept within tolerable limits.

In this context, there are configurations in which the soot particulate filter is heated up when the load has reached a first value or regeneration value, and the operating temperature is below a first value or regeneration temperature.

External measures aimed at raising the soot particulate filter to the requisite temperature for the soot combustion can consist of heating the gas stream or the filter matrix itself (for instance, electrically). It is likewise possible to obtain the requisite regeneration energy from the combustion taking place in the engine (for example, late fuel injection, after-injection, throttling and exhaust gas return).

As an alternative or in addition to this, it is also possible to use low concentrations of additives admixed to the fuel in order to reduce the soot burn-off temperature to approximately 300° C. through a catalytic effect. A similar effect is also achieved by catalytically coating the filter surfaces with transition metals.

In this context, there are methods in which the fresh air feed is initiated when the first operating temperature (regeneration temperature of the soot particulate filter) has been reached, which lies above 450° C., especially at 600° C. This makes it possible to ensure optimal burn-off conditions for regenerating the soot particulate filter.

There are configurations in which the cylinder valve is adjusted by means of an actuator that can be actuated by a control unit. The fresh air feed is regulated by adjusting the cylinder valve (or else several cylinder valves). Normally, the valve is regulated by the control cams of the camshaft that control the valve stroke and the stroke profile as well as the stroke times. But there are also configurations in which the valves are actuated directly (for instance, electromechanically or electromagnetically) by means of control elements.

Moreover, camshaft adjusters in which either the camshafts themselves are adjusted in the circumferential direction so as to change the control times, or else different or variable cam profiles can be selected in order to influence the regulation of the valves.

This makes it possible to take into consideration that the air or oxygen volume needed for the regeneration of the soot particulate filter is less than the volume needed for a combustion operation. In other words, the valve regulation prescribes a much lower fresh air supply for the deactivated “cold” cylinders. This can be done either by appropriately activating the actuator by means of an engine control unit or by switching over to a separate control cam which is likewise activated via the engine control unit.

In this context, there are configurations in which the control cams are configured in such a way that they bring about a reduced valve stroke, thus setting an optimized fresh air feed for the regeneration phase.

It is also possible for the outlet and inlet valves to be actuated independently from each other. Thus, for instance, the required volume of fresh air can be regulated via the inlet valves (activation of an actuator or change-over to a separate control cam with a reduced valve stroke), and the outlet valves are set as a function of the desired mode of operation.

For the regeneration of the particulate filter, the outlet valves are opened during the normal rhythm and with a normal valve stroke (the volume of fresh air is regulated by means of the inlet valves) and the air being conveyed through the cylinders by the pistons can escape into the exhaust gas system or into the soot particulate filter.

During operation when the cylinders are switched off (without actuation of the outlet valves), the outlet valves are switched over to a so-called zero cam profile, so that the outlet remains closed and the cylinders are operated exclusively as gas springs.

There are configurations in which, during the regeneration of the soot particulate filter, an operating state requested by the driver is maintained by means of the active cylinders. In this context, the power loss of the cylinders that are in the switched-off or fresh-air feed operation is compensated for by appropriately increasing the power of the cylinders that have remained active. The load increase associated with this for the remaining “firing cylinders” also ensures a greater exhaust gas enthalpy (higher exhaust gas temperature), thereby promoting the soot burn-off in the soot particulate filter.

As an alternative to the above-mentioned fresh air feed via the cylinder that is running “empty”, it is likewise possible to carry out partial cylinder switch-offs, that is to say, to allow individual cylinders to be carried along without fuel injection, and by conveying only fresh air, similar to the case with combustion misfiring.

In a similar manner, firing cycles can also be cyclically suppressed by deactivating the fuel injection and these cylinders can then be used to convey more fresh air or oxygen.

There are also configurations in which a control unit (especially an engine control unit) is provided for operating the internal combustion engine of a motor vehicle, said control unit being configured to carry out the method presented above.

An internal combustion engine that is provided with such a control unit can operate according to one of the following engine principles: gasoline engine, diesel engine or gas engine. In particular, however, the method according to the invention is intended for use in conjunction with gasoline engines having direct fuel injection.

Finally, the invention relates to motor vehicles with an internal combustion engine having the properties presented above. Such motor vehicles are suitable to meet present and future stricter requirements regarding soot particle emissions, also in the case of gasoline operation.

Additional advantageous configurations of the invention ensue from the subordinate claims and from the description below of preferred embodiments of the present invention.

The embodiments of the invention will now be described by way of example, making reference to the accompanying drawing. The following is shown:

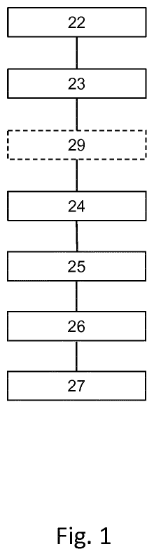

FIG. 1 a schematic sequence of an embodiment of the method according to the invention for the regeneration of a soot particulate filter;

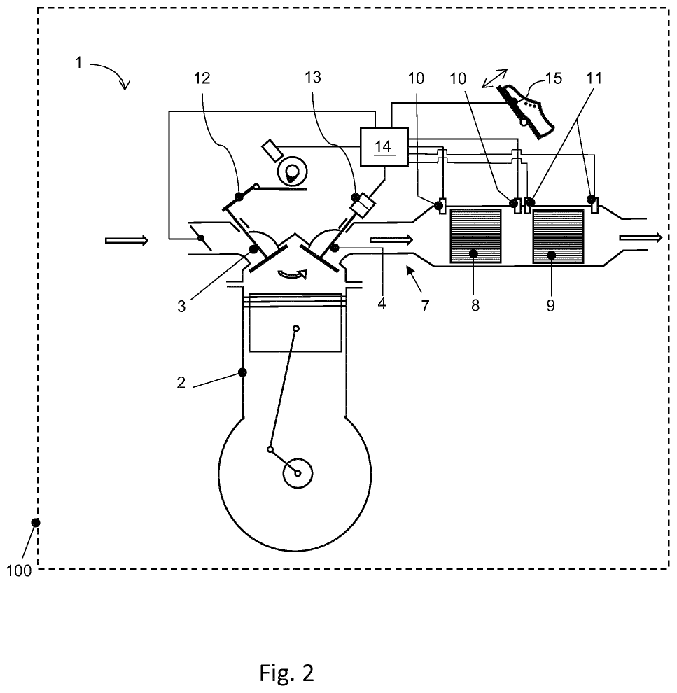

FIG. 2 a schematic depiction of an internal combustion engine arrangement with a soot particulate filter arranged in its exhaust tract;

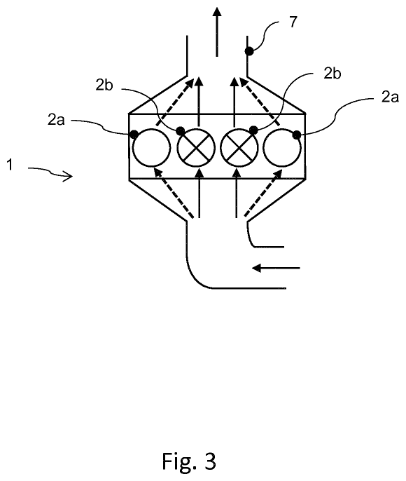

FIG. 3 an internal combustion engine with a switched-off cylinder, in which the method according to the invention can be carried out.

FIG. 1 shows the schematic sequence of a method according to the invention for the regeneration of a soot particulate filter. The method comprises Step 22: ascertaining a load value of the soot particulate filter, Step 23: measuring an operating temperature of the soot particulate filter, Step 24: switching off a cylinder of the internal combustion engine, Step 25: initiating a fresh air feed into the soot particulate filter via the switched-off cylinder, Step 26: adjusting a cylinder valve for regulating the fresh air feed, and Step 27: regenerating the soot particulate filter.

Step 29: heating up the soot particulate filter, is optionally provided. Step 29 is conditionally carried out when the load has reached a first value that corresponds to a regeneration value of the soot particulate filter.

As set forth here, the load value refers to a load value derived from a measurement or to a modeled load value of the soot particulate filter. A load value derived from a measurement is based, for example, on a pressure drop that is detected by means of two pressure sensors which are installed upstream and downstream from the soot particulate filter respectively, as seen in the flow direction. When the soot particulate filter is highly laden, the rising flow resistance increases the pressure drop (the pressure differential between the two pressure sensors). A load value can then be derived from this pressure differential.

In the case of a modeled load value, the ascertained operating states of the internal combustion engine serve as the basis for modeling a projected accumulation of soot over a given period of operation, taking into account the ascertained operating points or operating states. These two methods can also be combined with each other.

Step 25, initiating a fresh air feed into the soot particulate filter, can be conditionally carried out, namely, as a function of a given operating temperature of the soot particulate filter, which is preferably more than 450° C., especially above 600° C. The operating temperature of the soot particulate filter can be measured either directly by means of thermal measurements in or on the soot particulate filter or else indirectly by measuring the temperature of the exhaust gas that is flowing through the soot particulate filter. For this purpose, appropriate temperature sensors can be installed upstream from, downstream from, or else in the soot particulate filter.

FIGS. 2 and 3 show schematic depictions of an internal combustion engine in a motor vehicle that is suitable for carrying out the method according to the invention.

FIG. 2 schematically shows an internal combustion engine 1 having four cylinders 2 (see FIG. 3), each of which has an inlet valve 3 and an outlet valve 4. The fresh air feed is regulated by means of an intake pipe 5 with a throttle valve 6. The exhaust gas flows through an exhaust tract 7 in which an oxidation catalytic converter 8 and a particulate filter 9 are arranged consecutively as seen in the flow direction.

There are temperature sensors 10 upstream and downstream from the oxidation catalytic converter, whereas there are pressure sensors 11 upstream and downstream from the soot particulate filter 9.

Two alternatives are presented for the valve regulation. In this context, the inlet valve 3 is actuated by means of a camshaft control unit 12, and a control element 13 is shown for the inlet valve 4. The camshaft control unit 12 and the control element 13 constitute alternatives that can be realized alternatingly as well as in combination, that is to say, both the outlet valve 4 and the inlet valve 3 can be actuated by means of a control element 13, and conversely, the inlet valve 3 and the outlet valve 4 can be actuated by means of a camshaft control unit.

The engine is controlled by means of a control unit 14 (ECU) that is connected via signal lines to the throttle valve 6, to the camshaft control unit 12, to the control element 13, to the temperature sensors 10, to the pressure sensors 11 and to the gas pedal 15, by means of whose actuation a driver request (power demand) can be defined.

The internal combustion engine 1 is a component of a motor vehicle 100 and can also be integrated, for example, within the scope of a hybrid drive concept involving one or more electric motors.

The method presented above will now be carried out in the internal combustion engine 1 depicted in FIG. 2. The load value of the soot particulate filter 9 is ascertained by means of the pressure sensors 11, which determine a pressure drop or pressure differential between the inlet side and the outlet side of the soot particulate filter 9. A load value of the soot particulate filter 9 can be ascertained on this basis. As an alternative or in addition to this, the load value can also be modeled by the control unit 14 in that the soot particle load over a given period of time can be ascertained by detecting the operating points. In this manner, it is possible ascertain whether the load value has reached a regeneration value at which the soot particulate filter 9 has to be regenerated.

In parallel to this, the exhaust gas temperature or the operating temperature of the soot particulate filter 9 is measured by means of one or both temperature sensors 10 in that the exhaust gas temperature is measured. In alternative embodiments, it is also possible to install a measuring sensor directly on or in the soot particulate filter 9.

If the load value of the soot particulate filter corresponds to a regeneration value and if the operating temperature of the soot particulate filter corresponds to a regeneration temperature (for instance, above 450° C. or at 600° C.), then the actual regeneration process is initiated.

If the operating temperature does not correspond to the regeneration temperature, in other words, if the operating temperature is below the regeneration temperature, then the soot particulate filter 9 is heated up, either by means of external heating measures or else by means of heating measures effectuated by the engine (increasing the load point, additional fuel injection).

In order to start the regeneration procedure, one or more cylinders 2b are switched off. In FIG. 3, the switched-off cylinders 2b are marked with an X, while the outer cylinders 2a continue to be operated. Since the oxygen demand is lower for the regeneration than for the fuel combustion, the fresh air feed is adjusted by means of the cylinder valves (inlet valve 3 and/or outlet valve 4).

Within the scope of the method, an engine control unit 14 actuates the camshaft control unit 12 in such a way that a cylinder cam is activated which establishes a reduced opening cross section, thus diminishing the amount of fresh air.

As an alternative, this can be done by means of control elements 13 which correspondingly actuate either the inlet valve and/or the outlet valve. In this context, the control element 13 is likewise regulated by means of the control unit 14. In this operating state, the outer cylinders 2a continue to run in the normal mode of operation while the inner cylinders 2b run as fresh-air pumps, whereby the fresh air feed and thus the volume of oxygen are regulated by means of the cylinder valves 3, 4. The exhaust gas that has been enriched with additional fresh air is conveyed via the oxidation catalytic converter into the soot particulate filter 9, where the oxygen triggers and effectuates the soot combustion in the soot particulate filter 9.

By means of the control unit 14, a driver request (power demand) that has been selected prior to the regeneration is still maintained in that the power loss caused by the de-activation of the inner cylinders 2a is compensated for by a load increase of the two outer cylinders 2b. The regulation is thus carried out in such a way that the change in the operating state from normal operation over to regeneration operation does not affect the driver request and such a change is hardly noticeable. At the same time, increasing the load point of the two outer cylinders raises the temperature of the exhaust gas, as a result of which the soot particulate filter 9 can be additionally heated up which, in turn, promotes the burn-off of the soot accumulations.

In this process, the control unit 14 carries out the method according to FIG. 1. The internal combustion engine shown is especially configured as a gasoline engine with direct fuel injection and it is a component of the motor vehicle 100.

The person skilled in the art can derive other variants and embodiments of the invention on the basis of the claims.

### LIST OF REFERENCE NUMERALS

1 internal combustion engine
2 cylinders
2a outer cylinders
2b inner cylinders
3 inlet valve
4 outlet valve
5 intake pipe
6 throttle valve
7 exhaust tract
8 oxidation catalytic converter
9 particulate filter, soot particulate filter, gasoline particulate filter
10 temperature sensors
11 pressure sensors
12 camshaft control unit
13 control element
14 control unit
15 gas pedal
100 motor vehicle

1. A method for the regeneration of a soot particulate filter that is installed on the outlet side of an internal combustion engine, comprising:
ascertaining a load value of the soot particulate filter;
measuring an operating temperature of the soot particulate filter;
switching off a cylinder of the internal combustion engine;
initiating a fresh air feed into the soot particulate filter via the switched-off cylinder
adjusting a cylinder valve so as to regulate the fresh air feed;
regenerating the soot particulate filter.

2. The method according to claim 1, further comprising heating up the soot particulate filter when the load has reached a first load value, if the operating temperature is below a first temperature value.

3. The method according to claim 2, whereby the fresh air feed is initiated when the first operating temperature of the soot particulate filter has been reached.

4. The method according to claim 1, whereby the cylinder valve is adjusted by means of an actuator that can be activated by a control unit.

5. The method according to claim 1, whereby the cylinder valve is adjusted by switching over to a separate control cam.

6. The method according to claim 5, whereby the control cam is configured in such a way that it brings about an elevated valve stroke, thus increasing the fresh air feed.

7. The method according to claim 1, whereby, during the regeneration of the soot particulate filter, an operating state requested by the driver is maintained by means of the active cylinders.

8. A control unit for operating an internal combustion engine of a motor vehicle, said control unit being configured to carry out a method according to claim 1.

9. An internal combustion engine with a control unit according to claim 8, whereby the internal combustion engine operates according to one of the following engine principles: gasoline engine, diesel engine and gas engine.

10. A motor vehicle with an internal combustion engine according to claim 9.

11. The method according to claim 3, wherein the first operating temperature of the soot particulate filter is above 450° C.

12. The method according to claim 11, wherein the first operating temperature of the soot particulate filter is 600° C.
